(19) United States
(12) Patent Application Publication
(10) Pub. No.: US 2017/0269382 A1
(43) Pub. Date: Sep. 21, 2017

(54) MYOPIC SUNGLASSES

(71) Applicant: Daomin WANG, Shenzhen City (CN)

(72) Inventor: Daomin WANG, Shenzhen City (CN)

(21) Appl. No.: 15/459,618

(22) Filed: Mar. 15, 2017

(30) Foreign Application Priority Data
Mar. 16, 2016 (CN) 201620198772.5

(51) Int. Cl. G02C 9/00; G02C 7/02; G02C 7/10

(52) U.S. Cl. CPC G02C 9/00; G02C 7/10; G02C 7/02; G02C 2200/02

(57) ABSTRACT

The present application disclosed myopic sunglasses including a myopic glasses underframe and a sunglasses face frame, where the inner circle of the myopic glasses underframe is provided with a first groove, the first groove is provided with a first magnet group, the sunglasses face frame is provided with a second groove, the second groove is provided with a second magnet group, and the sunglasses face frame is coupled to the myopic glasses underframe by the absorptive force between the first magnet group and the second magnet group. The myopic sunglasses provided by the present application are convenient to wear, firm in structure and not easy to be damaged or scratched.

### FIELD OF THE DISCLOSURE

The present application relates to the technical area of glasses, in particular, relates to a kind of myopic sunglasses.

### DESCRIPTION OF THE RELATED ART

Persons suffering from myopic eyes need to wear myopic glasses to correct vision. Therefore, when they encounter shining of strong sunlight in summer, these persons cannot wear sunglasses to avoid harmful stimulation to eyes from strong sunlight.

In order to solve the above problems, people invented new types of myopic sunglasses, commonly including dyed myopic sunglasses, color-changeable myopic sunglasses, integrated myopic sunglasses and add-on chip myopic sunglasses. Due to the lack of perspective rates, dyed myopic sunglasses will increase eye fatigue and affect vision acuity. Because of the high price, color-changeable sunglasses are difficult to be promoted or used widely. Integrated myopic sunglasses render sunglasses' lens and myopic lens on one pair of glasses, which are to be switched by being turned up and down, so they cannot be used as normal myopic lens. Add-on chip myopic sunglasses can fix sunglasses on the outside of myopic lens through the designing of hanging clamp pieces, so they are comparably more practical. But due to the diversity of forms of spectacle frames as well as different widths and thickness of nasal frames, when clamping distances of the hanging clamp pieces are too wide, the hanging clamp piece could not combine very tightly to the myopic glasses, so the sunglasses are liable to fall off from the myopic lens, while when the clamping distances are too narrow, then sunglasses cannot be worn and the hanging clamp pieces may scratch the underframe of the myopic lens.

### SUMMARY

It is an object of the present application to provide a type of myopic sunglasses, which are convenient to be worn, firm in structure and not liable to be damaged or scratched.

A type of myopic sunglasses, including myopic glasses underframe and sunglasses face frame, the inner circle of the myopic glasses underframe is provided with first groove, the first groove is provided with first magnet group, the sunglasses face frame is provided with second groove, the second groove is provided with second magnet group, and the sunglasses face frame is hanged on the myopic glasses underframe by the adhesive force between the first magnet group and the second magnet group.

The beneficial effects of the myopic sunglasses disclosed in the application are that the myopic sunglasses connected tightly by magnet is not liable to fall off, convenient to be worn, firm in structure and not easy to be damaged or scratched.

### BRIEF DESCRIPTION OF THE DRAWINGS

FIG. 1 is a schematic structural diagram of the myopic sunglasses of the present application.

### DETAILED DESCRIPTION

Following is the further description of the present application with reference to detailed embodiments and attached drawings.

A method for manufacturing myopic sunglasses is provided, including the method for manufacturing myopic glasses underframes and the method for manufacturing sunglasses face frame.

The method for manufacturing myopic glasses underframe includes the following steps:

Put plastic materials into the CNC fine carving machine for carving the inside and outside circles; Put to the roller for grinding; Carve the first groove in the inner side of the inside circle; Place the first magnet group into the first groove, and fill the first groove with resin adhesive; Dry; Grind, to make myopic glasses underframe;

The method for manufacturing sunglasses face frame includes the following steps: Weld the metal frame provided with the second groove into glasses face frame; Grind; conduct electroplating; and attach the second magnet group into the second groove with glue so as to make sunglasses face frame;

Assemble the sunglasses face frame and the myopic glasses underframe by the adsorptive force between the first magnet group and the second magnet group.

The produced myopic sunglasses connected tightly by magnet, is not liable to fall off, convenient to wear, firm in structure and not easy to be damaged or scratched.

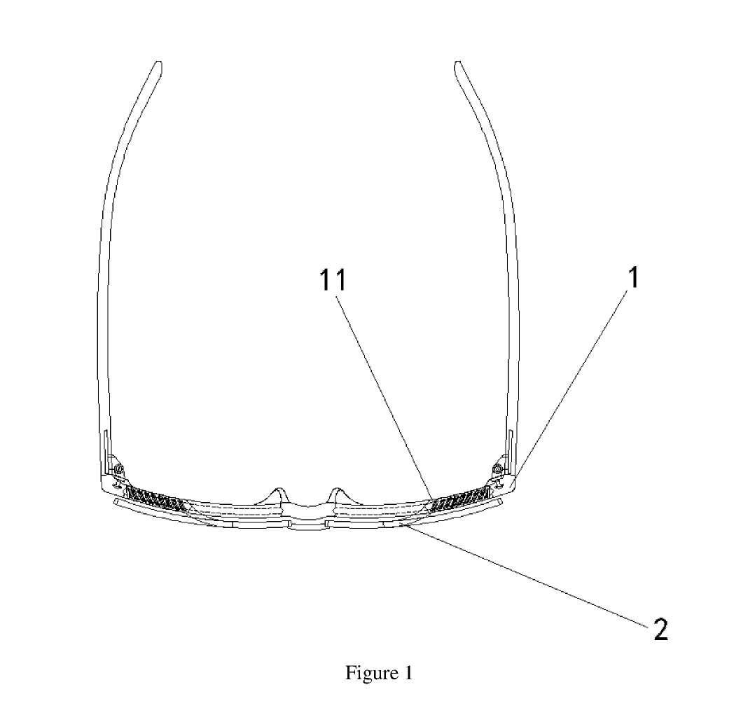

Referring to FIG. 1, a type of myopic sunglasses including myopic glasses underframe 1 and sunglasses face frame 2, the inner circle of the myopic glasses underframe 1 is provided with a first groove, the first groove is provided with a first magnet group 11, the first magnet group 11 is fixed in the first groove by the resin adhesive filled in the first groove, the sunglasses face frame 2 is provided with a second groove, the second groove is provided with a second magnet group, the second magnet group is attached in the second groove with glue, and the sunglasses face frame 2 is hanged onto the myopic glasses underframe 1 by adsorptive force between the first magnet group and the second magnet group.

Finally, it is to be noted that the above embodiments are merely illustrative of the technical solution of the present application, and are not intended to limit the scope of protection of the present application. Although the present application is described in detail with reference to the preferred embodiments, it should be understood by those skilled in the art that modifications and equivalents may be made to the technical solution of the present application without departing from the spirit and scope of the technical solution.

What is claimed is:

1. Myopic sunglasses, comprising:
a myopic glasses underframe and a sunglasses face frame, an inner circle of the myopic glasses underframe is provided with a first groove, the first groove is provided with a first magnet group, the sunglasses face frame is provided with a second groove, the second groove is provided with a second magnet group, and the sunglasses face frame is coupled to the myopic glasses underframe by an absorptive force between the first magnet group and the second magnet group.
